(19) United States
(12) Patent Application Publication
(10) Pub. No.: US 2026/0211930 A1
(43) Pub. Date: Jul. 23, 2026

(54) METHODS AND SYSTEMS FOR PROACTIVE GENERATION OF INSIGHTS FROM SOURCE DATA

(71) Applicant: QlikTech International AB, Lund (SE)

(72) Inventors: Steven Pressland, Borough Green (GB); Khoa Tan Nguyen, Lund (SE); Nasser Bumpus, Boston, MA (US)

(21) Appl. No.: 19/454,742

(22) Filed: Jan. 21, 2026

Related U.S. Application Data
(60) Provisional application No. 63/747,496, filed on Jan. 21, 2025.

(51) Int. Cl. G06F 16/34

(52) U.S. Cl. CPC G06F 16/345

(57) ABSTRACT

Systems and methods for proactively generating insights from source data are described. A system may analyze source data to identify data patterns and generate insights without requiring explicit user queries. The system may utilize machine learning models, including large language models, to enhance natural language processing capabilities and generate relevant insights. Insights may be presented through a feed-like interface, allowing users to interact with and provide feedback on the generated insights. The system may incorporate a query resolution subsystem to interpret user intent and an associative engine to maintain data relationships. A visualization recommendation engine may automatically generate appropriate charts for insights, while natural language generation techniques may create narrative descriptions of data patterns. The system may maintain contextual awareness to tailor insights based on user roles and permissions, providing a personalized and proactive analytics experience.

### CROSS-REFERENCE TO RELATED PATENT APPLICATION

This application claims priority to U.S. Prov. App. No. 63/747,496, filed on Jan. 21, 2025, the entirety of which is incorporated by reference herein.

### BACKGROUND

Natural Language Processing (NLP) and Machine Learning (ML) technologies have increasingly been used to enhance data analysis and visualization. These technologies enable users to interact with data analytics platforms using natural language queries, which are interpreted to generate relevant insights and visualizations. However, traditional approaches often require manual exploration and analysis, which can be time-consuming and may miss important patterns or trends. Additionally, many users lack the technical expertise to effectively query and visualize complex data. As the volume and complexity of data continue to grow, there is a need for more efficient and accessible methods to extract meaningful insights from large datasets.

### SUMMARY

It is to be understood that both the following general description and the following detailed description are exemplary and explanatory only and are not restrictive. Described herein are systems and methods for proactive generation of insights based on source data. The systems may comprise a proactive insight generation component integrated with an analytics platform. This component may analyze source data to automatically identify significant patterns, trends, or anomalies. The systems may utilize large language models to enhance natural language processing capabilities and to generate relevant insights without requiring explicit user queries.

The systems may present insights to users through a feed-like interface, similar to social media platforms. In some embodiments, in lieu of or in addition to the feed-like interface, insights may be provided via a preferred communication channel, such as an in-app notification, an email notification, a mobile device notification, a combination thereof, and/or the like. In this manner, insights may be delivered to users in a push-type manner Users may interact with insights, providing feedback to refine future recommendations. The systems may incorporate a query resolution subsystem to interpret user intent as well as an associative engine to maintain data relationships and enable rapid exploration. The systems may automatically generate appropriate charts corresponding to insights, and natural language generation techniques may be employed to create narrative descriptions of data patterns in insights. In some examples, the systems may maintain contextual awareness to tailor insights based on user roles and permissions. In some aspects, the system may distinguish between “generic” applications and “curated” applications. For applications without pre-existing context, referred to herein as “generic applications,” users may define trigger expressions within a trigger definition. By contrast, “curated applications” may include those with a semantic layer, comprising master items and sheets, and the system may automatically suggest analysis specifications based on the pre-existing semantic layer elements, streamlining the setup process.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A shows an example system, according to aspects of the present disclosure.

FIG. 1B shows an example system, according to aspects of the present disclosure.

FIG. 2 shows an example user interface, according to aspects of the present disclosure.

FIG. 3 shows an example sequence diagram, according to aspects of the present disclosure.

FIG. 4 shows example elements related to insight generation, according to aspects of the present disclosure.

FIG. 5A shows a user interface of an analytics platform, according to aspects of the present disclosure.

FIG. 5B shows another user interface of the analytics platform, according to aspects of the present disclosure.

FIG. 5C shows a further user interface of the analytics platform, along with one or more proactively-generated insights, according to aspects of the present disclosure.

FIG. 5D shows a further user interface of the analytics platform, along with one or more proactively-generated insights, according to aspects of the present disclosure.

FIG. 5E shows a further user interface of the analytics platform, along with one or more proactively-generated insights, according to aspects of the present disclosure.

FIG. 5F shows one or more proactively-generated insights, according to aspects of the present disclosure.

FIG. 5G shows a further user interface of the analytics platform, along with one or more proactively-generated insights, according to aspects of the present disclosure.

FIG. 6 shows an example system, according to aspects of the present disclosure.

FIG. 7 shows a flowchart for an example method, according to aspects of the present disclosure.

FIG. 8 shows a flowchart for an example method, according to aspects of the present disclosure.

FIG. 9 shows a flowchart for an example method, according to aspects of the present disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not. Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Described herein are systems and methods for proactive generation of insights based on source data. The systems may comprise a proactive insight generation component integrated with an analytics platform. This component may analyze source data to automatically identify significant patterns, trends, or anomalies. The systems may utilize large language models to enhance natural language processing capabilities and to generate relevant insights without requiring explicit user queries. The systems may present insights to users through a feed-like interface, similar to social media platforms. In some embodiments, in lieu of or in addition to the feed-like interface, insights may be provided via a preferred communication channel, such as an in-app notification, an email notification, a mobile device notification, a combination thereof, and/or the like. In this manner, insights may be delivered to users in a push-type manner. Users may interact with insights, providing feedback to refine future recommendations. The systems may incorporate a query resolution subsystem to interpret user intent as well as an associative engine to maintain data relationships and enable rapid exploration. The systems may include a visualization recommendation engine to automatically generate appropriate charts corresponding to insights, and natural language generation techniques may be employed to create narrative descriptions of data patterns in insights. In some examples, the systems may maintain contextual awareness to tailor insights based on user roles and permissions.

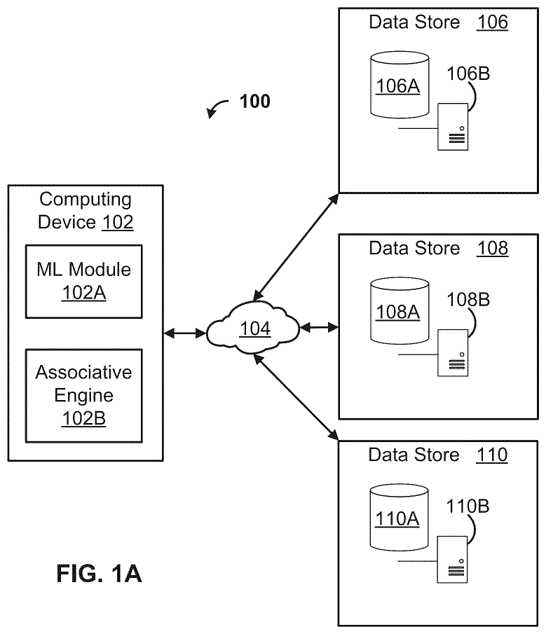

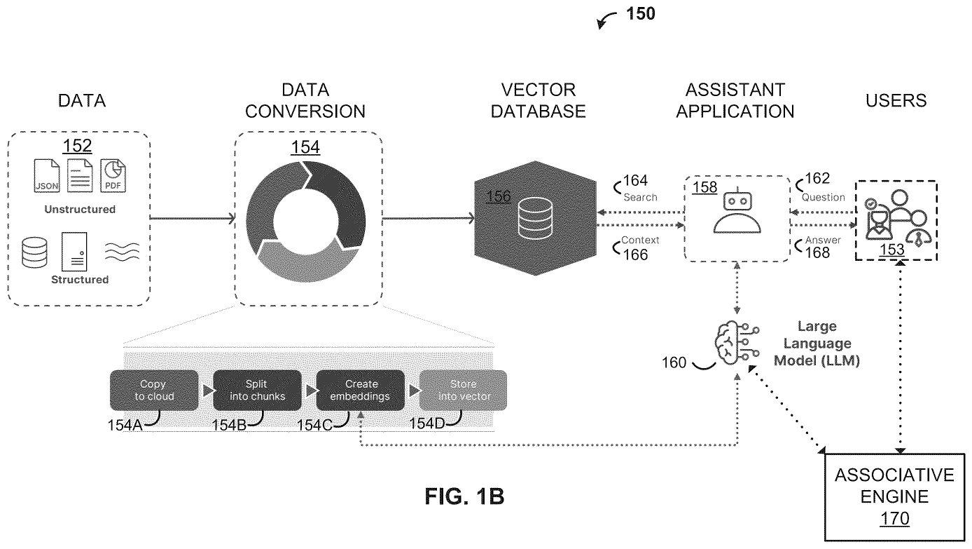

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide instantaneous calculation of aggregates, selections, and filters as further described herein.

Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a business intelligence platform, a data warehouse, a customer relationship management system, or other types of systems. This integration may allow the system 100 to access additional data, provide more comprehensive insights, or offer additional features to the users.

As an example, turning now to FIG. 1B, an example system 150 is shown. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown).

In some aspects, the system 150 may be utilized to transform data 152 into a format that may be consumed by one or more Large Language Models (LLMs). For example, the data 152 may comprise both structured data and unstructured data. The structured data may be related to one or more analytics “apps” as further described herein, which may include one or more data models, data tables, information regarding connections to various sources such as databases, spreadsheets, and/or web services in an analytics system, etc. The unstructured data may comprise file-based sources, such as presentations, mail archives, text documents, PDFs, transcripts, etc.

The data 152 may be split into manageable chunks in a data conversion process 154. At step 154A, the data 152 may be copied to a cloud-based environment. At step 154B, the data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For ease of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Though FIG. 1B only shows one LLM 160, it is to be understood that the system 150 may comprise multiple LLMs 160, such as a primary LLM and a secondary LLM as further described herein. Each embedding may comprise a numerical representation of the corresponding chunk of the data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162 The question 162 may comprise a NL query, an image, a recording, a combination thereof, and/or the like. The question 162 may be sent to the assistant application 158. The assistant application 158 may perform a search 164 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” which are reusable dimensions, measures, and visualizations defined within an app, ensuring consistency and reusability across the app. As used herein, a “semantic layer” refers to a collection of pre-defined data model elements within an analytics application, including master items and sheets, that provide contextual information about the data structure, relationships, and visualization layouts. As used herein, a “generic application” refers to an analytics application that lacks a pre-existing semantic layer, requiring users to manually define context and trigger expressions for insight generation. Additionally, as used herein, a “curated application” refers to an analytics application that includes a semantic layer comprising master items and sheets. The master items and sheets within an app may collectively form that app's semantic layer. The semantic layer may enable the system 150 to understand the meaning and relationships of data elements without requiring explicit user configuration. The semantic layer may provide pre-existing context that the system 150 may leverage to automatically recommend analysis specifications. For curated applications that include such a semantic layer, the system 150 may suggest trigger expressions based on the master items and sheets, rather than requiring users to build trigger expressions from scratch. In contrast, for generic applications without a semantic layer, users may create context within a trigger definition manually.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user's 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user's 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153).

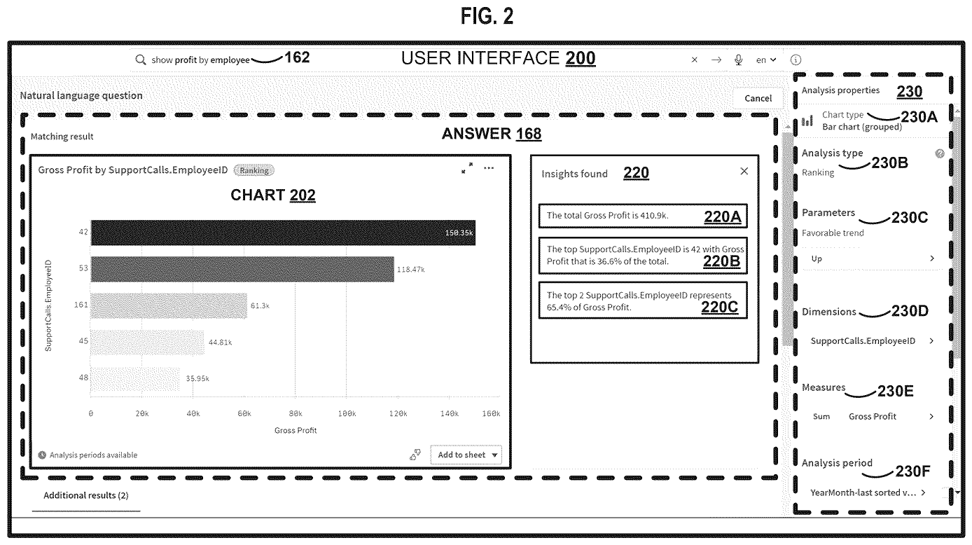

Turning now to FIG. 2, an example user interface 200 is shown. The user interface 200 may provide an interactive environment for users to engage with the natural language processing and insight generation capabilities of the systems described herein. The user interface 200 may be displayed on a computing device, such as the computing device 102 shown in FIG. 1A (e.g., accessed through a web browser or application running on a client device).

The user interface 200 may include a question 162 input field. The question input field 162 may allow users to enter natural language queries or requests for insights about specific data or visualizations. The question 162 shown in the user interface 200 may correspond to the question 162 described in FIG. 1B. Users may enter natural language queries into this field to request insights about their data. The question 162 may be processed by the assistant application 158 as described in relation to FIG. 1B. The input field may support various types of queries, ranging from simple data requests to complex analytical questions. Users may ask questions such as “What were the top products last quarter?” or “Show me sales trends by region.” The system may interpret these natural language inputs and convert them into appropriate data operations.

The user interface 200 may also display an answer 168 in response to the user's question 162. The answer 168 shown in the user interface 200 may correspond to the answer 168 generated by the system 150 as described in FIG. 1B. The answer 168 may comprise natural language text that provides insights, explanations, and interpretations of the data. The answer 168 may be generated using the large language model(s) 160 and may incorporate contextual metadata from the associative engine 170. The natural language response may be tailored to the user's specific query and may include relevant details, comparisons, and observations about the data. The answer 168 may comprise natural language text that provides insights, explanations, or responses to the user's query.

A chart 202 may be displayed within the user interface 200. The chart 202 may provide a visual representation of data relevant to the user's query or the current analytical context. The chart 202 may be generated based on data retrieved from the associative engine 170 and/or from the vector database 156. The chart 202 may be interactive, allowing users to click on specific elements to request additional insights or explanations. The visualization may be automatically selected based on the type of analysis being performed and the nature of the data being displayed. The chart 202 may be a visual representation of data relevant to the user's query or the current context of analysis.

The user interface 200 may generate and display a plurality of insights 220. These insights may be automatically generated based on the current data context and may provide users with additional analytical observations beyond their specific query. The plurality of insights 220 may include a first insight 220A, a second insight 220B, and a third insight 220C. Each insight may represent a different analytical finding or observation about the data. These insights may be generated using the template-based approaches described herein, combined with the natural language generation capabilities of the large language models. The insights may be generated by the system 150 based on the data represented in the chart 202, the user's query, and other contextual information. Each of these insights may provide different perspectives or analyses of the data.

The system may also provide analysis properties 230 that support the generated insights. The analysis properties 230 may include detailed analytical information that forms the foundation for the insights presented to the user. These properties may include a first analysis property 230A, a second analysis property 230B, a third analysis property 230C, a fourth analysis property 230D, a fifth analysis property 230E, and a sixth analysis property 230F. Each analysis property may contain specific data points, measurements, calculations, or metadata that contribute to the overall insight generation process. The analysis properties 230 may be derived from the contextual metadata provided by the associative engine 170 and may include information such as current selection states, hypercube data, statistical measures, and comparative values.

The analysis properties 230 may serve multiple purposes within the system. They may provide the factual foundation for the natural language insights, ensuring that the generated text is grounded in actual data rather than hallucinated information. The properties may also be used to construct prompts for the large language models, providing the necessary context and data points for generating accurate and relevant responses. Additionally, the analysis properties 230 may be used to determine appropriate visualizations and to guide the narrative structure of the insights.

The user interface 200 may support interactive exploration of data. Users may click on elements of the chart 202 to request explanations or additional insights about specific data points. The system may respond to these interactions by generating new insights or by providing more detailed analysis of the selected elements. This interactive capability may be supported by the associative engine 170. The associative engine 170 can quickly retrieve relevant contextual information about any selected data point or visualization element. The chart 202 and the insights 220 may be dynamically updated based on user interactions. For example, if a user selects a particular bar in the chart 202, the system 150 may generate new insights specific to that selection. This interactive capability may be facilitated by the associative engine 170. The associative engine 170 can quickly retrieve and analyze relevant data based on user selections.

The user interface 200 may also include additional interactive elements not explicitly shown in FIG. 2. These may include filters, dropdown menus, or buttons that allow users to refine their queries, change data views, or access additional features of the system 150. The integration of natural language input, visual data representation, and AI-generated insights in a single interface demonstrates the system's capability to provide a comprehensive analytical experience. This approach may allow users of varying technical expertise to gain valuable insights from complex data sets.

The user interface 200 may be part of a larger application or dashboard system. It may be one of several “sheets” within an analytics app, as described earlier. The data and insights presented in the user interface 200 may be derived from the data model and connections established within such an app. The system 150 may use both the vector database 156 and the associative engine 170 to generate the content displayed in the user interface 200. The vector database 156 may provide relevant context and background information based on the user's query, while the associative engine 170 may perform real-time calculations and data retrievals to support the insights and visualizations.

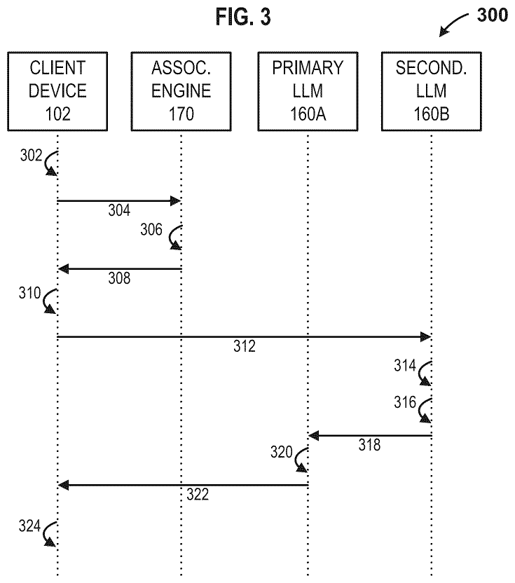

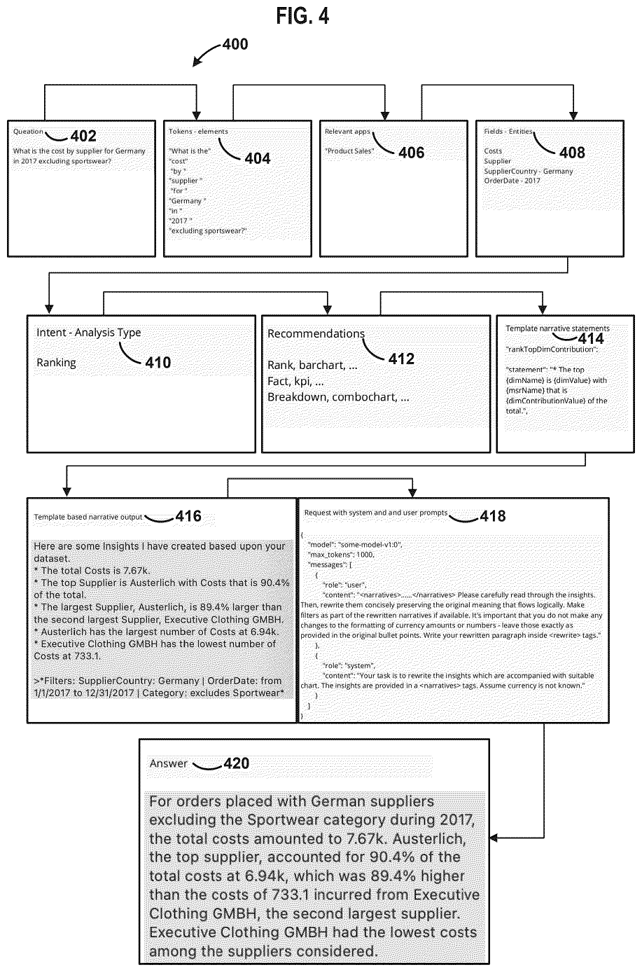

Referring to FIG. 3 and FIG. 4, a sequence diagram 300 and a query-to-insight pipeline 400 collectively illustrate an example process for generating insights in an analytics environment. The sequence diagram 300 depicts communication flow and interaction patterns between the client device 102, the associative engine 170, a primary LLM 160A, and (optionally) a secondary LLM 160B. The primary LLM 160A and the secondary LLM 160B may be implementations of the large language model 160 shown in FIG. 1B, which processes natural language queries and assists in generating responses.

The query-to-insight pipeline 400 illustrates the inputs and outputs at various stages of the insight generation process (e.g., per the sequence diagram 300), showing how a natural language query 402 is transformed through successive processing stages into a refined narrative response 420 and accompanying visualizations. The natural language query 402 corresponds to the natural language query 162 shown in FIG. 1B and FIG. 2, which users 153 may send to the assistant application 158. Together, FIG. 3 and FIG. 4 demonstrate how the system transforms user queries into actionable insights through coordinated processing across multiple components.

The primary LLM 160A and the secondary LLM 160B may be large language models configured to process natural language and generate narrative content. These models may be accessed through the machine learning module 102A resident at the client device 102. In some cases, the primary LLM 160A and the secondary LLM 160B may be transformer-based models. For example, the secondary LLM 160B may be a BERT (Bidirectional Encoder Representations from Transformers) model configured to classify the intent of user queries and match the user queries to appropriate data model entities. The BERT model may utilize bidirectional context to improve understanding of complex user queries and enable more accurate interpretation of user requests and improved mapping to relevant data sources. Other transformer-based models may include GPT (Generative Pre-trained Transformer) and T5 (Text-to-Text Transfer Transformer), which are particularly well-suited for natural language processing tasks. These models use self-attention mechanisms to process input data, allowing them to capture long-range dependencies and contextual information effectively. Other examples are possible as well, including recurrent neural network models such as Long Short-Term Memory (LSTM) and Gated Recurrent Unit (GRU) networks designed to handle sequential data.

The sequence diagram 300 begins with step 302. At step 302, the client device 102 receives a user query or chart interaction requesting insights about specific data. The client device 102 may receive the user query through a user interface (e.g., the user interface 200), which provides an interactive environment for users to engage with the natural language processing and insight generation capabilities. As shown in FIG. 4, the query-to-insight pipeline 400 receives a natural language query 402 at an input stage. The natural language query 402 may contain a user question similar to the natural language query 162 shown in FIG. 2, where a user may enter a query such as “show profit by employee.” For example, the natural language query 402 may include a request for cost information by supplier for a specific region and time period, such as “What is the cost by supplier for Germany in 2017 excluding sportswear?” The user query may be a natural language query. The chart interaction may be a selection made by a user within a visualization, such as the chart 202 shown in FIG. 2.

In some embodiments, the system may track and analyze user selections and data analyses performed behind-the-scenes, such as tracking expressions used, aggregations performed, and visualizations created. The system may support both query-driven insight generation, where a user provides a natural language query, and proactive insight generation, where insights are generated without an explicit user query, for example at data reload, on a schedule, or in response to detected changes, as further described herein.

At step 304, the client device 102 sends a request to the associative engine 170 for contextual metadata extraction. The associative engine 170 corresponds to the associative engine 102B of the client device 102, which stores data models in-memory and manages associations between data elements. The request may specify data elements relevant to the user query or chart interaction. The associative engine 170 forms the core of the data processing capabilities and maintains associations between all data points, allowing for rapid exploration and analysis across multiple dimensions. The associative model enables the system to uncover hidden insights and relationships that might be missed in traditional query-based approaches. The associative engine 170 may store one or more data models in-memory and manage associations between data elements, providing instantaneous calculation of aggregates, selections, and filters. The associative engine 170 may retrieve data from the plurality of data stores 106, 108, 110 via the network 104 to support the contextual metadata extraction.

At step 306, the associative engine 170 processes the request. The associative engine 170 retrieves a current selection state, hypercube data, and data model relationships. The selection state may indicate filters and selections applied by a user, such as specific regions, products, or time periods selected. The hypercube data may comprise aggregated values across multiple dimensions, including dimensions, measures, and their values. The associative engine 170 may also retrieve the data model schema and relationships indicating how fields and tables are connected, the user's selection or query history to maintain context in a conversational thread, and any annotations or rules defined in a corresponding analytics-system app such as labels like “High-value customer” or custom calculations defined by the user. The contextual metadata gathered by the associative engine 170 corresponds to the context 166 shown in FIG. 1B, which is used by the assistant application 158 to provide the answer 168.

At step 308, the associative engine 170 returns the requested data back to the client device 102. The requested data may include aggregations, filters, and dimensional information. The returned data may also include n-dimensional aggregated datasets, referred to as hypercubes, that ground insight narratives and visualizations. The hypercube definitions may include relevant dimensions and measures and aggregations such as sum, average, count, or max. Hypercube definitions may also include calculated expressions that derive measures from other fields. The returned data enables the client device 102 to generate, for example, the analysis properties 230 shown in FIG. 2, including the chart type indicator 230A, analysis type indicator 230B, parameters indicator 230C, dimensions indicator 230D, measures indicator 230E, and analysis period indicator 230F.

With continued reference to FIG. 3 and FIG. 4, at step 310, the client device 102 processes the received data and generates contextual metadata. The contextual metadata may comprise information describing the analytical context of the user query. The contextual metadata may be used to tailor insights and recommendations, ensuring that users receive information that is both relevant and appropriate for their specific needs and permissions. The system may maintain awareness of the user's context, including their role, previous interactions, and data access permissions. As shown in FIG. 4, the query-to-insight pipeline 400 processes the natural language query 402 to extract token elements 404. The token elements 404 may represent individual linguistic components parsed from the natural language query 402. For example, the token elements 404 may include terms identifying a requested metric, dimensions, filters, and exclusions. In an illustrative example, the token elements 404 may include “cost,” “supplier,” “Germany,” “2017,” and “excluding sportswear.” The system may tokenize the query, remove stop words, and identify candidate entities such as dates, numbers, and potential field names. The system may then perform an app search to identify apps associated with the user that are relevant to the query, based on matches between query tokens and knowledge base content stored in the vector database 156.

At step 312, the client device 102 sends the contextual metadata and a data summary to the secondary LLM 160B. The primary LLM 160A and/or the secondary LLM 160B may be configured to classify user intent and resolve named entities. In some cases, the secondary LLM 160B may be a transformer encoder trained for intent classification and entity detection. For example, the secondary LLM 160B may be a BERT model. The secondary LLM 160B may receive a candidate entity list and available analysis types to constrain outputs and improve accuracy. As illustrated in FIG. 4, the query-to-insight pipeline 400 determines a relevant application identifier 406 that specifies an analytics application containing data pertinent to the natural language query 402. For example, the relevant application identifier 406 may identify a “Product Sales” application as containing the relevant data for a cost-by-supplier query. The query-to-insight pipeline 400 extracts and maps field entities 408 to the natural language query 402. The field entities 408 may identify specific data model elements including measures, dimensions, and filter values corresponding to the token elements 404. In an illustrative example, the field entities 408 may map “cost” to a Costs measure, “supplier” to a Supplier dimension, “Germany” to a SupplierCountry field value, and “2017” to an OrderDate field value. Entity candidates may be assembled by searching app metadata and data model entities stored in the vector database 156. Tokens may match field names, table names, measure titles, or other artifacts. The system may also type-match candidate values, such as interpreting a token as a date range or a numeric threshold.

At step 314, the primary LLM 160A and/or the secondary LLM 160B performs analysis and constructs an initial prompt. The initial prompt may contain the user query, contextual metadata, and relevant template patterns. The primary LLM 160A and/or the secondary LLM 160B may generate candidate recommendations based on the intent and resolved entities. As shown in FIG. 4, the query-to-insight pipeline 400 performs an intent classification 410 that categorizes an analytical purpose of the natural language query 402. The intent classification 410 may determine a type of analysis to be performed, such as ranking analysis, comparison analysis, or trend analysis. The intent classification 410 corresponds to the analysis type indicator 230B shown in FIG. 2, which indicates the analysis type such as “Ranking.”

The intent may map the query to an analysis type, such as comparison, ranking, breakdown, trend, correlation, or other supported types. Named entity resolution may select the best-matched data model entities for the query from candidate sets. The system may provide the model with the candidate entity list and the available analysis types to constrain outputs and improve accuracy. The analysis types may include period-over-period change, trend detection, anomaly detection, contribution analysis, ranking shift, variance to target or forecast, distribution shift, correlation or relationship analysis, and segmentation or cluster outliers. A series of predefined analysis types may be used to reduce noise and ensure relevance. These analysis types may be trend-based and designed to produce interpretable, actionable outputs.

At step 316, the primary LLM 160A and/or the secondary LLM 160B continues processing by constructing prompts. The prompts may combine factual data with structural guidance from templates. Each recommendation may include an analysis type, a visualization type, and a hypercube definition for executing the analysis. Recommendations may be scored by relevance, confidence, expected interpretability, and historical user engagement. A top-scored recommendation may be selected for execution. As illustrated in FIG. 4, the query-to-insight pipeline 400 generates visualization recommendations 412 based on the intent classification 410. The visualization recommendations 412 may suggest appropriate chart types and visual representations for presenting analytical results, similar to the chart type indicator 230A shown in FIG. 2 which indicates the chart type as “bar chart (grouped).” Visualization selection may map analysis types to visualization types. For example, line charts may be selected for time-series trends, stacked bars may be selected for contribution analysis, box plots may be selected for distribution analysis, scatter plots may be selected for relationship analysis, bar charts may be selected for ranking analysis (e.g., as shown in the chart 202), KPI visualizations may be selected for fact-based insights, and combo charts may be selected for breakdown analysis. Other examples are possible as well, depending on the query, data, etc. The system may select and generate the most appropriate chart types based on the data being analyzed and the user's query, considering factors such as data types, relationships, and best practices in data visualization.

A narrative template corresponding to the analysis type may be determined by an upstream device within the system, such as a server(s) (106A, 108A, 110A) in communication with the client device 102. The template may include parameterized statements populated with values computed from the aggregated dataset. As shown in FIG. 4, template narrative statements 414 provide structured narrative patterns corresponding to the intent classification 410. The template narrative statements 414 may contain parameterized text structures for expressing analytical findings. The query-to-insight pipeline 400 generates a template-based narrative output 416 by populating the template narrative statements 414 with computed values from a data analysis. The template-based narrative output 416 may produce preliminary insight statements describing analytical results, similar to the insights found 220 shown in FIG. 2, which includes the first insight 220A, second insight 220B, and third insight 220C.

For example, a template narrative statement for ranking analysis may include a statement such as “The top {dimName} is {dimValue} with {msrName} that is {dimContributionValue} of the total.” The elements in curly braces may be parameterized placeholders within a template narrative statement used for ranking analysis. Element{dimName} may be a name of a dimension being analyzed. For example, in a ranking analysis, the dimension name may be “Supplier” or “SupportCalls.EmployeeID”, etc. Element {dimValue} may be a name of a specific dimensional value that ranks at the top, such as “Austerlich” (a supplier name) or “42” (an employee ID). Element {msrName} may be a name of a measure being used in the ranking, such as “Costs” or “Gross Profit”. And element {dimContributionValue} may be a percentage contribution of the top dimensional value to the total measure. The template-based narrative output 416 may present insights about total values, identify top contributors and their percentage contributions, and note comparative relationships between entities. In this particular example, the template-based narrative output 416 may state: “The total Costs is 7.67k. The top Supplier is Austerlich with Costs that is 90.4% of the total. The largest Supplier, Austerlich, is 89.4% larger than the second largest Supplier, Executive Clothing GMBH. Austerlich has the largest number of Costs at 6.94k. Executive Clothing GMBH has the lowest number of Costs at 733.1.”

At step 318, the primary LLM 160A and/or the secondary LLM 160B returns preliminary results (e.g., the secondary LLM 160B may return the preliminary results to the primary LLM 160A). The preliminary results may include draft findings and recommended chart specifications. An additional insights finder may be resident at the assistant application 158, the associative engine 170, the client device 102, and/or a device of the systems 100 or 150 in communication therewith. The additional insights finder may use the aggregated dataset and app knowledge base to identify related insights not captured by the template, such as key contributors driving a change, segments with extreme variance, or related entities in other apps that provide explanatory context. The app knowledge base may be stored in the vector database 156, which semantically indexes embeddings created during the data conversion process 154. A visualization recommendation engine, which may be resident at the assistant application 158, the associative engine 170, the client device 102, and/or a device of the systems 100 or 150 in communication therewith, may automatically select and generate the most appropriate chart types based on the data being analyzed and the user's query, considering factors such as data types, relationships, and best practices in data visualization.

As further shown in FIG. 3 and FIG. 4, at step 320, the primary LLM 160A creates an enhanced prompt. The enhanced prompt may combine the original context, draft findings, and narrative instructions. The primary LLM 160A may generate a complete natural language narrative and refined visualization specifications. The primary LLM 160A may rewrite or refine the template-based narrative to improve clarity, correctness, tone, and readability. As illustrated in FIG. 4, the query-to-insight pipeline 400 constructs LLM request prompts 418 to refine the template-based narrative output 416. The LLM request prompts 418 may include system and user instructions for a large language model (e.g., the primary LLM 160A and/or the secondary LLM 160B) to rewrite the insights while preserving numerical accuracy and incorporating filter context. For example, the LLM request prompts 418 may include a user prompt instructing the primary LLM 160A and/or the secondary LLM 160B to “Please carefully read through the insights. Then, rewrite them concisely preserving the original meaning that flows logically. Make filters as part of the rewritten narratives if available. It's important that you do not make any changes to the formatting of currency amounts or numbers-leave those exactly as provided.” Or similar. The LLM request prompts 418 may also include a system prompt such as “Your task is to rewrite the insights which are accompanied with suitable chart. The insights are provided in a narratives tags. Assume currency is not known” or similar. The system may employ natural language generation techniques to create narrative descriptions of data patterns, trends, and anomalies, complementing the visual representations. The primary LLM 160A and/or the secondary LLM 160B may be used to refine these narratives, ensuring they are clear, concise, and use appropriate terminology for the user's context.

At step 322, the primary LLM 160A and/or the secondary LLM 160B sends a final insight response to the client device 102. The final insight response may include both narrative text and accompanying visualizations. The final insight response corresponds to the answer 168 shown in FIG. 1B and FIG. 2, which the assistant application 158 provides to the users 153. As shown in FIG. 4, the query-to-insight pipeline 400 produces a refined narrative response 420 as a final output. The refined narrative response 420 may present a coherent natural language summary that integrates the analytical findings, filter conditions, and comparative observations derived from the source data. For this particular example, the refined narrative response 420 may state: “For orders placed with German suppliers excluding the Sportswear category during 2017, the total costs amounted to 7.67k. Austerlich, the top supplier, accounted for 90.4% of the total costs at 6.94k, which was 89.4% higher than the costs of 733.1 incurred from Executive Clothing GMBH, the second largest supplier. Executive Clothing GMBH had the lowest costs among the suppliers considered.” Before returning a final answer, the system may validate outputs for security and governance, check for ungrounded statements, and format the response. Validation may include cross-checking narrative statements against computed values and ensuring that fields referenced are authorized for the requesting user. The system may reduce ungrounded model statements by requiring that each narrative claim be traceable to an evidence item (e.g., stored the app knowledge base).

At step 324, the client device 102 outputs the generated insights for presentation to a user. The generated insights may be displayed through the user interface 200, which includes the chart 202 and the insights found 220 comprising the first insight 220A, second insight 220B, and third insight 220C. The sequence diagram 300 and the query-to-insight pipeline 400 together illustrate how the system combines data processing capabilities of the associative engine 170 (which corresponds to the associative engine 102B shown in FIG. 1A) with natural language understanding and generation capabilities of the primary LLM 160A and the secondary LLM 160B (which are implementations of the large language model 160 shown in FIG. 1B) to provide contextually aware insights from complex data sets.

The insights may be presented as card-like objects in a feed, and in some embodiments, insights may additionally or alternatively be delivered via a preferred communication channel, such as an in-app notification, an email notification, a mobile device notification, a combination thereof, and/or the like, enabling push-type delivery of insights to users. The insights may include prompts to explore further or take actions such as adding to a sheet. The system implements a closed-loop approach to continuously improve the quality and relevance of insights, including user feedback mechanisms where users can rate, comment on, or dismiss insights, providing valuable input for the system to learn from. The system may track which insights users interact with most frequently to prioritize similar types of insights in the future. As new data becomes available from the data stores 106, 108, 110 via the network 104, the system may reevaluate previous insights and generate updated or new insights as appropriate. The combination of automated visualizations and natural language narratives helps users better understand and communicate insights derived from their data, reducing time-to-insight by proactively generating and pushing insights so users can quickly identify important patterns or changes in their data without manual exploration.

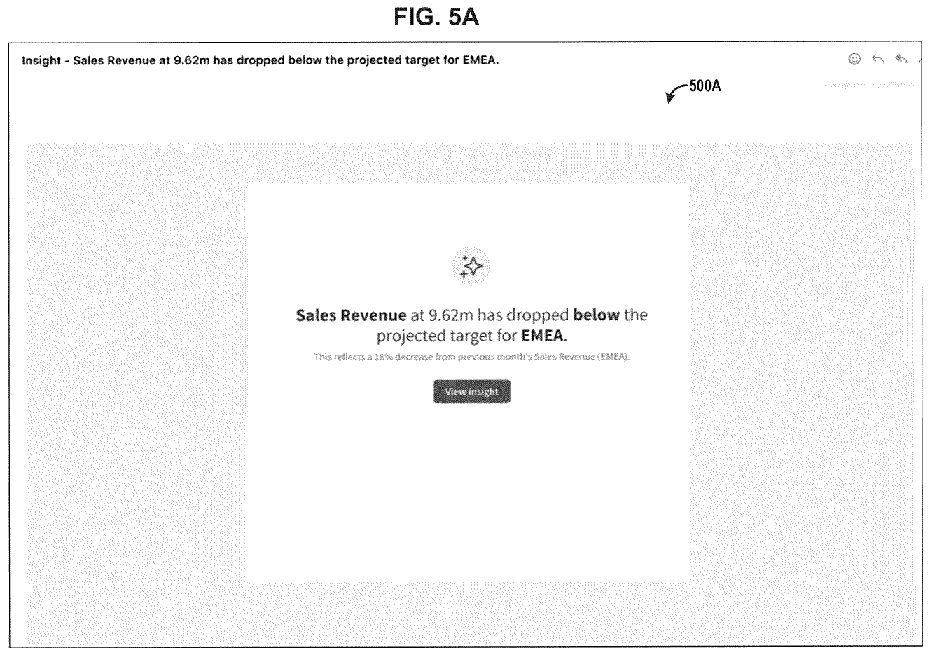

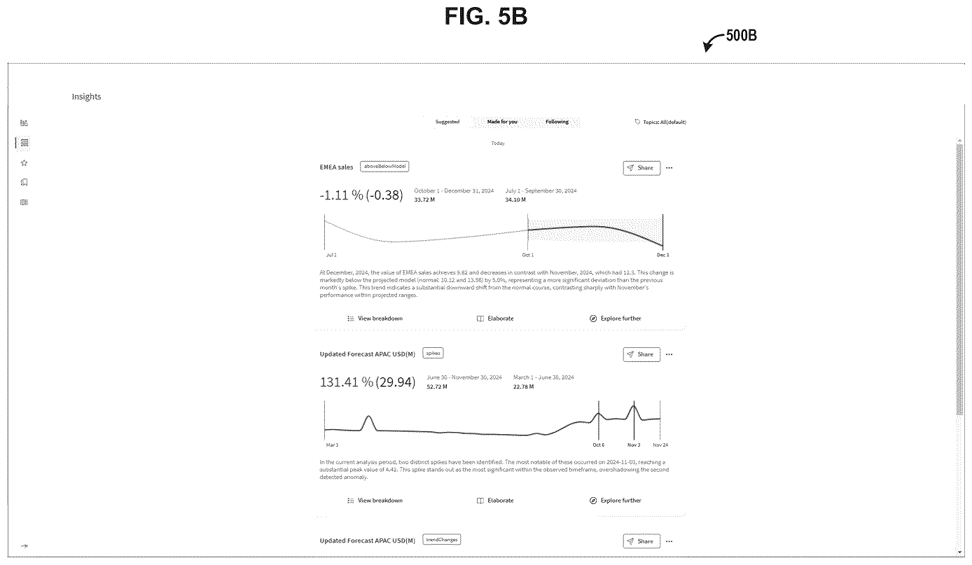

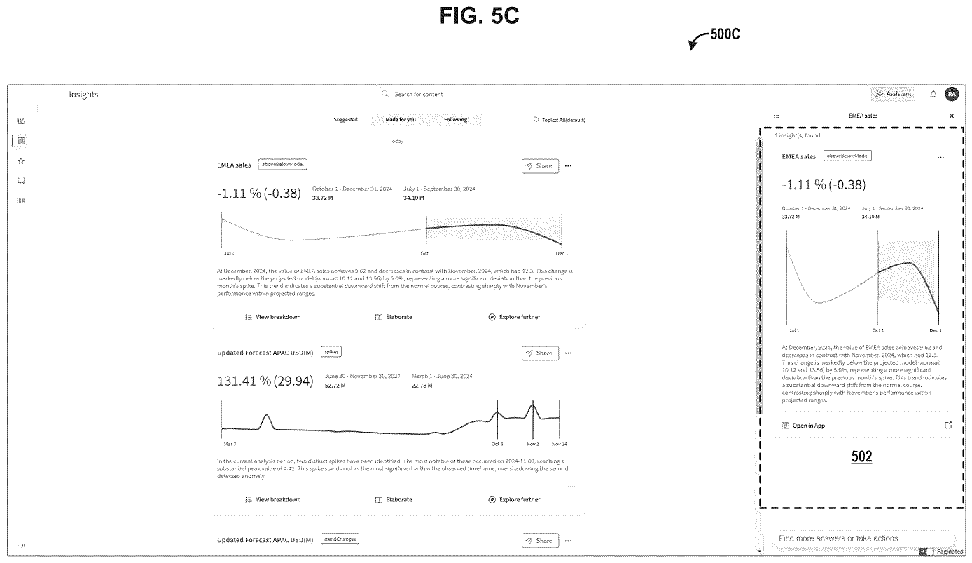

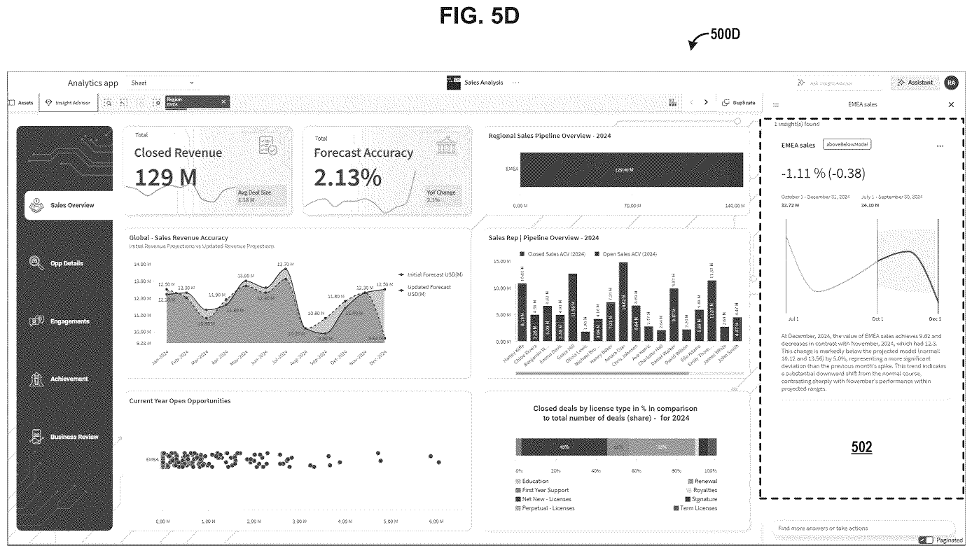

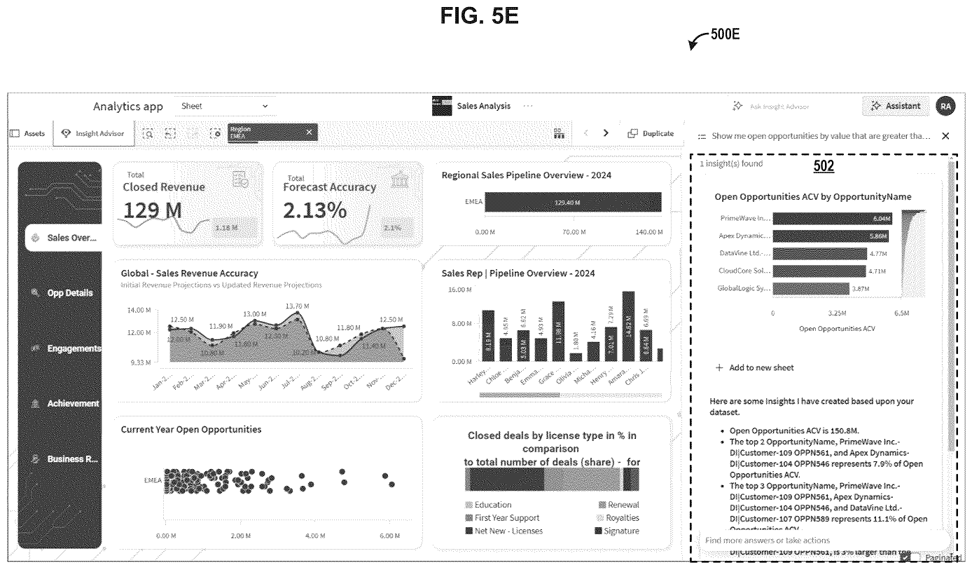

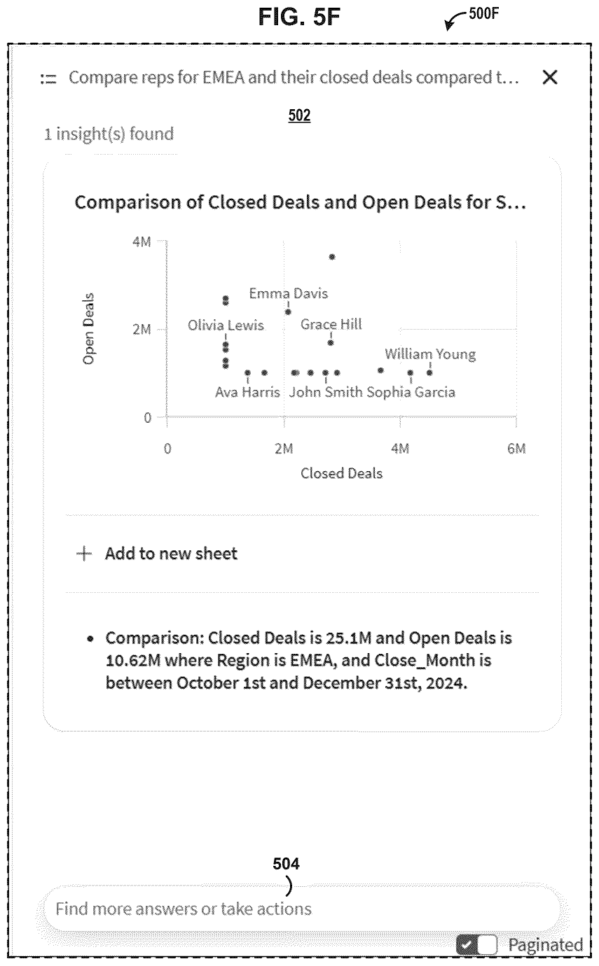

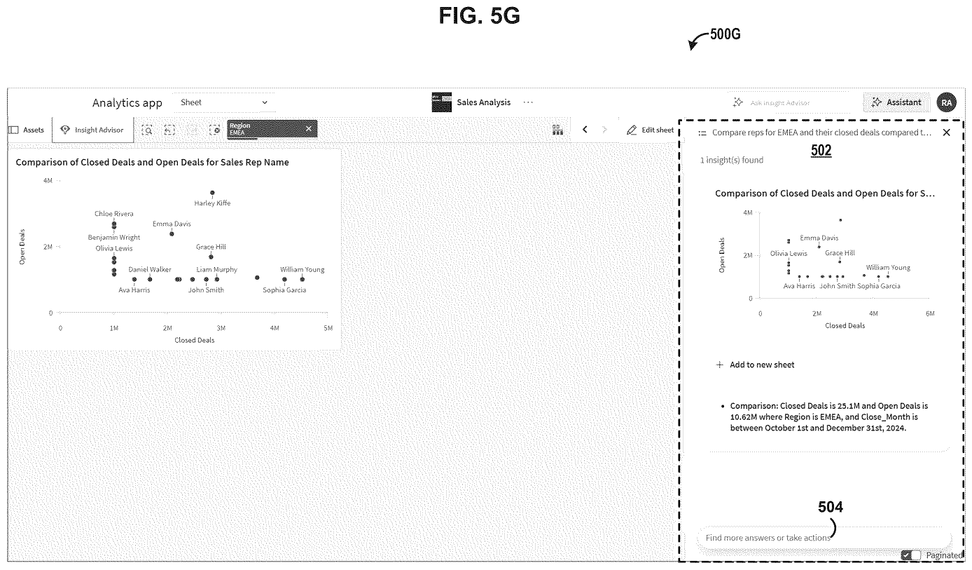

Referring to FIG. 5A, an insight notification interface 500A illustrates an example of the user interface 200 of FIG. 2. The insight notification interface 500A may be configured for presenting a proactively generated insight to a user, where the insight is generated by the system 150 using the assistant application 158, the large language model 160, the primary LLM 160A, the secondary LLM 160B, etc. The insight notification interface 500A may display a notification card containing an insight statement, similar to the answer 168 generated in response to processing by the assistant application 158. The insight notification interface 500A may provide action elements allowing a user to access further details about the proactively generated insight. The insight notification interface 500A may represent a mechanism for delivering proactively generated insights to users 153 without requiring explicit user queries such as the natural language query 162.

The system 150 may generate insights via the assistant application 158, the large language model 160, the primary LLM 160A, the secondary LLM 160B, the associative engine 170, etc. For example, the assistant application 158 may process source data retrieved from the plurality of data stores 106, 108, 110 via the network 104 and generate insight representations comprising narrative text and visualization objects, similar to the insights found 220 and the chart 202. As another example, the large language model 160 may refine narrative descriptions to improve clarity and readability, as described with reference to the refined narrative response 420 generated by the query-to-insight pipeline 400.

In some implementations, a method performed by the systems may include sending, to a client device such as the client device 102, a notification comprising an insight representation. The client device 102 may be caused to output the insight representation. The insight representation may include narrative text describing a data pattern, similar to the template-based narrative output 416 and the refined narrative response 420. The insight representation may include a visualization object corresponding to the data pattern, similar to the chart 202 generated based on the visualization recommendations 412. That is, a “visualization object” may comprise a graphical representation of data that may be generated as part of an insight representation. For example, a visualization object may comprise a chart definition, a rendered chart image, or both, similar to the chart 202 generated based on the visualization recommendations 412. The client device 102 may render the insight representation (e.g., the narrative text and the visualization object) within the insight notification interface 500A.

Referring to FIG. 5B, an insight feed interface 500B illustrates an example of the user interface 200 of FIG. 2. The insight feed interface 500B may be configured for presenting proactively generated insights within the analytics platform, where the insights are generated via the assistant application 158, the large language model 160, the primary LLM 160A, the secondary LLM 160B, the associative engine 170, etc. The insight feed interface 500B may display multiple insight cards arranged within a scrollable feed area, where each insight card presents content similar to the insights found 220 comprising the first insight 220A, second insight 220B, and third insight 220C. The insight feed interface 500B may include action elements associated with each insight card.

The system 150 may support proactive insight generation in multiple modes. A first mode may comprise an initial feed mode. In the initial feed mode, the system 150 may generate a curated list of insights for a user 153 to review before taking action within an application. A second mode may comprise an insights at selection mode. In the insights at selection mode, the system 150 may mine insights as charts refresh while a user 153 makes selections and explores data via the associative engine 170. A third mode may comprise an insights at reload mode. In the insights at reload mode, the system 150 may detect changes after a data reload from the data stores 106, 108, 110 and generate insights highlighting material changes over time. A fourth mode may comprise a scheduled insights mode. In the scheduled insights mode, the system 150 may periodically execute analysis types against metrics or slices to surface recurring patterns. A fifth mode may comprise an event-driven insights mode. In the event-driven insights mode, the system 150 may trigger insight generation upon anomalies, threshold crossings, or external events. Other modes and examples are possible as well.

The system 150 may score and rank candidate insights (e.g., before delivery to the insight feed interface 500B). Candidate insight scoring may consider magnitude. Magnitude may comprise absolute change, relative change, z-score, or anomaly score. Candidate insight scoring may consider business relevance. Business relevance may comprise whether a metric is a key performance indicator, whether the metric appears in frequently used sheets, or whether the metric maps to business objectives. Candidate insight scoring may consider novelty. Novelty may comprise whether a pattern differs from expected seasonal or historical behavior. Candidate insight scoring may consider user context, similar to the context 166 gathered by the associative engine 170. User context may comprise role, permissions, geography, products, and historical engagement. Candidate insight scoring may consider evidence quality. Evidence quality may comprise confidence in pattern detection and stability of a supporting aggregated dataset.

The system 150 may utilize a combination of the semantic layer, including fields, master items, dashboards, and charts, to identify data elements of importance. Additionally, the system 150 may incorporate input from the large language model 160 to provide industry context regarding what data patterns may be significant, thereby populating insights on areas that matter to users. Additionally, the system 150 may employ machine learning libraries for pattern detection calculations. Pattern detection may include spike detection, which may detect spikes in the data using peak-finding algorithms to identify significant spikes based on dynamic thresholds for prominence and height. Pattern detection may include baseline shift analysis, which may analyze baseline shifts in the data using statistical measures such as mean, median, and z-scores to detect changes in baseline values. Pattern detection may include model deviation analysis, which may forecast data trends using time-series forecasting models and compare actual data against model predictions to identify deviations above or below the model. Pattern detection may include record detection, which may identify record high or low values in the data and compare them to historical records. Pattern detection may include trend change analysis, which may analyze trends in the data using regression techniques to detect changes in trends by comparing slopes of historical and current segments. Other pattern detection techniques are possible as well.

After pattern detection calculations are completed, the system 150 may apply a sensitivity algorithm to determine whether a detected pattern is significant enough to present. The sensitivity algorithm may account for chronological order, such as the newness of the insights, and weight, such as the impact of the insights on the source data. If a pattern value exceeds a threshold (e.g., a sensitivity level, a sensitivity threshold, etc.), the corresponding insight may be output/provided. In some examples, the large language model 160 may be used to summarize the pattern into an insight with additional context.

In some embodiments, the system 150 may generate a forecast based on data provided up to a current time period. From this forecast, a range may be established for expected data point values. The sensitivity level may be set based on how many data points reside within the forecast range, so as not to overwhelm the user with excessive alerts. The forecast may be based on linear regression or other forecasting techniques. The sensitivity may not be static but may adjust algorithmically to ensure quality insights are generated. The algorithm may be calibrated based on historical data points residing within the forecast. The number of standard deviations may be used for defining anomalies, and sensitivity may be based on that number. The sensitivity may be refined based on the frequency of alerts generated.

In the event-driven insights mode, the semantic layer may facilitate trigger-based insight generation by providing a unified representation of data elements and their relationships. For curated applications that include a semantic layer, the system 150 may automatically configure triggers based on master items and sheets, enabling the system to detect relevant anomalies or threshold crossings without requiring manual configuration. For generic applications lacking a semantic layer, a user may create context within a trigger definition to define an analysis specification. The trigger definition may specify conditions under which insight generation should occur, such as when a metric exceeds a threshold value, when an anomaly is detected in a time series, or when an external event is received. The user may define the trigger expression by specifying the relevant measures, dimensions, and threshold conditions. The analysis specification defined within the trigger definition may identify the analysis type, the data elements to be analyzed, and the conditions that should initiate insight generation. In this way, the event-driven insights mode may support both curated applications with automatic trigger configuration and generic applications with user-defined trigger expressions. The user 153 may define the trigger expression by specifying the relevant measures, dimensions, and threshold conditions. For example, the user 153 may interact with the assistant application 158 to specify trigger parameters. The trigger expression may reference data elements from the data stores 106, 108, 110, for example. Additionally, or in the alternative, referring to FIG. 2, the user 153 may specify measures corresponding to the measures indicator 230E and dimensions corresponding to the dimensions indicator 230D. The trigger expression may define threshold values, comparison operators, and temporal conditions that determine when insight generation should be initiated. The analysis specification defined within the trigger definition may identify the analysis type, similar to the analysis type indicator 230B shown in FIG. 2, the data elements to be analyzed, and the conditions that should initiate insight generation. Referring to FIG. 3, the trigger definition may be processed via the client device 102 (e.g., assistant application 158 and the LLM 160) communicating with the associative engine 170 to retrieve contextual metadata at step 306. And, at step 308, aggregated data for evaluating the trigger condition may be received. In this way, the event-driven insights mode may support both curated applications with automatic trigger configuration and generic applications with user-defined trigger expressions.

In a method for generating insights from source data, the method may comprise causing, based on an insight representation and user context information, a client device such as the client device 102 associated with a user session to present the insight representation within a feed interface. The feed interface may comprise the insight feed interface 500B. The insight representation may comprise narrative text, similar to the refined narrative response 420, and a visualization object, similar to the chart 202. The visualization object may be generated as a time-series visualization based on an aggregated result computed by the associative engine 170. The time-series visualization may depict trends, changes, or patterns over temporal dimensions.

Referring to FIG. 5C, an analytics interface 500C illustrates an example of the user interface 200 of FIG. 2. The analytics interface 500C may be configured for presenting proactively generated insights within the analytics platform, where the insights are generated by the system 150 through the coordinated operation of the assistant application 158, the large language model 160, and the associative engine 170, etc. The analytics interface 500C includes a natural language query input 502 displayed in a right panel of the analytics interface 500C. The natural language query input 502 may receive natural language queries from users 153, similar to the natural language query 162 processed by the assistant application 158.

The analytics interface 500C may support both query-driven insight generation and proactive insight generation. In query-driven insight generation, a user 153 may provide a natural language query through the natural language query input 502, which is processed through the query-to-insight pipeline 400 as described with reference to FIG. 3 and FIG. 4. In proactive insight generation, insights may be generated without an explicit user query, for example using the machine learning module 102A and the associative engine 102B to analyze source data from the data stores 106, 108, 110.

With continued reference to FIG. 5C, the analytics interface 500C may integrate with the assistant application 158 and the associative engine 170 to provide contextual insights based on a user's analytical context. As an example, the assistant application 158 may receive natural language queries through the natural language query input 502 and may perform searches 164 against the vector database 156 to receive context 166. The associative engine 170 may gather contextual metadata about the analytical context of users 153, as described with reference to step 306 of the sequence diagram 300. The contextual metadata may include data hypercubes, selection states, data model schemas, and query history. The associative engine 170 may communicate with the assistant application 158 to provide contextual information, as described with reference to step 308. The contextual information may enhance the relevance and accuracy of generated insights, similar to the answer 168.

A method for generating insights may comprise receiving, based on a user session associated with an analytics application, user context information identifying a user role. The user context information may be used to determine appropriate insights for the user 153. For example, the analytics interface 500C may display insights tailored to the user role based on the received user context information, where the insights are generated through the processing steps described with reference to the sequence diagram 300 and the query-to-insight pipeline 400.

Referring to FIG. 5D, an analytics dashboard interface 500D illustrates an example of the user interface 200 of FIG. 2. The analytics dashboard interface 500D may be configured for presenting proactively generated insights within the analytics platform, where the insights are generated by the system 150 using the assistant application 158, the large language model 160, and the associative engine 170, etc. The analytics dashboard interface 500D includes a natural language query input 502 to allow users 153 to interact with the assistant application 158. The natural language query input 502 may receive natural language queries from users 153 in a manner similar to the natural language query 162 described with reference to FIG. 1B. The natural language query input 502 may enable users 153 to enter queries requesting specific data analyses or insights, which are processed through the query-to-insight pipeline 400. The assistant application 158 may process queries received through the natural language query input 502 and generate responsive insights, similar to the answer 168.

The system 150 may determine an analysis specification based on user context information. The user context information may identify a user role associated with a user session. The analysis specification may define a data analysis not explicitly requested by a user 153 associated with the user session. For example, the system 150 may determine, based on access control information, that a user 153 is a member of an executive team. The access control information may operate at multiple layers. The multiple layers may include app-level access, field-level access, and row-level access. The system 150 may determine, based on historical interaction data associated with the user role, the analysis specification. The historical interaction data may indicate data analyses that similar users generally perform. The system 150 may present insights based on data analyses that similar users generally perform, where the insights are generated through the processing described with reference to the sequence diagram 300 involving the client device 102, the associative engine 170, the primary LLM 160A, and the secondary LLM 160B. The system 150 may automatically perform the data analysis and provide results to the user 153 via a feed without requiring the user 153 to explicitly request the analysis.

Referring to FIG. 5E, an analytics interface 500E illustrates an example of the user interface 200 of FIG. 2. The analytics interface 500E may present query-driven insights based on a natural language request entered via the natural language query input 502 of the analytics interface 500E. The natural language query input 502 may receive queries such as “Show me open opportunities by value that are greater than [value]” from users 153, similar to the natural language query 162 and the natural language query 402.

The analytics interface 500E may receive, based on user interaction, a selection state applied to source data retrieved from the data stores 106, 108, 110. The analytics interface 500E may process the query through the query-to-insight pipeline 400. The query-to-insight pipeline 400 may perform tokenization to extract token elements 404 from the natural language query. The token elements 404 may represent individual linguistic components parsed from the natural language query including terms identifying the requested metric, dimensions, filters, and exclusions.

With continued reference to FIG. 5E, the analytics interface 500E may determine, based on the selection state, an analysis type selected from a predefined set of analysis types. The analytics interface 500E may perform intent classification 410 to categorize the analytical purpose of the natural language query. The intent classification 410 may determine the type of analysis to be performed, similar to the analysis type indicator 230B. For example, the intent classification 410 may identify a ranking analysis type or a comparison analysis type. The analytics interface 500E may perform field entity resolution to extract and map field entities 408 to the natural language query. The field entities 408 may identify specific data model elements including measures, dimensions, and filter values corresponding to the token elements 404, similar to the dimensions indicator 230D and the measures indicator 230E.

The additional insights finder (resident at the assistant application 158, the associative engine 170, the client device 102, and/or a device of the systems 100 or 150 in communication therewith) may use the aggregated dataset computed by the associative engine 170 and an app knowledge base stored in the vector database 156 to identify related insights not captured by a template. The additional insights finder may identify related dimensions or measures to test. The additional insights finder may identify related apps and evidence that provide explanatory context. Hypercube definitions may include calculated expressions. The calculated expressions may derive measures from other fields.

Referring to FIG. 5F, an insight interface 500F illustrates an example of the user interface 200 of FIG. 2. The insight interface 500F may be configured for presenting a proactively generated insight within the analytics platform, where the insight is generated by the system 150 through the coordinated operation of the assistant application 158, the large language model 160, the associative engine 170, etc. A user query may be entered via the natural language query input 502, similar to the natural language query 162 and the natural language query 402. For example, the user query may request a comparison of representatives for a region and closed deals associated with the representatives. The insight interface 500F further includes an insight summary 504 displayed below a visualization. The insight summary 504 may present a narrative description describing a comparison, similar to the refined narrative response 420 generated by the query-to-insight pipeline 400.

The insight interface 500F may present a visualization generated in response to the user query, similar to the chart 202. The system 150 may determine an analysis type based on the user query through the intent classification 410 performed by the secondary LLM 160B. For example, the system 150 may classify the user query as a comparison analysis type. The system 150 may map the comparison analysis type to a visualization type based on the visualization recommendations 412. For example, the system 150 may map the comparison analysis type to a scatter plot visualization type.

With continued reference to FIG. 5F, the system 150 may generate, based on the analysis type and a selection state, an aggregated dataset representing a comparison between multiple measures. The aggregated dataset may be computed by the associative engine 170 as described with reference to step 306 and step 308 of the sequence diagram 300. For example, the aggregated dataset may represent a comparison between closed deals and open deals.

The system 150 may generate, based on the aggregated dataset, an insight object comprising a visualization object and a narrative description (e.g., an insight card, as described herein). The insight object may include an insight_id field comprising a unique identifier for the insight object. The insight object may include an app_id field and an app_version field comprising application and version information used to generate the insight object, where the application information may correspond to the relevant application identifier 406. The insight object may include an analysis_type field comprising the analysis type used to compute the insight object, similar to the analysis type indicator 230B and the intent classification 410. For example, the analysis_type field may indicate a comparison analysis type.

The insight object may include a context field comprising filters, selections, time range, and segment context for the analysis, similar to the context 166 gathered by the associative engine 170. The insight object may include an evidence field comprising aggregated dataset references supporting the insight object. For example, the evidence field may comprise a hypercube definition and result hashes, where the hypercube data is retrieved by the associative engine 170 as described with reference to step 306. The insight object may include a narrative field comprising the narrative description, similar to the refined narrative response 420. The insight object may include a visualization field comprising the visualization object, similar to the chart 202. For example, the visualization field may comprise a visualization type and a visualization definition based on the visualization recommendations 412.

The insight object may include a score field comprising a ranking score used to order insight objects within a feed, such as the insight feed interface 500B. The insight object may include an actions field comprising suggested actions. For example, the actions field may comprise an action to add the visualization object to a sheet. The insight object may include security_tags comprising information supporting access control checks and safe rendering. The insight object may include timestamps comprising creation time, update time, and validity window. Other examples are possible as well.

The narrative description displayed in the insight summary 504 may be generated based on a narrative template, similar to the template narrative statements 414. For example, the system 150 may select a narrative template corresponding to the comparison analysis type and populate the narrative template with values computed from the aggregated dataset, producing the template-based narrative output 416 which is then refined by the primary LLM 160A as described with reference to step 320 to produce the refined narrative response 420.

The insight interface 500F may include an action element. For example, the insight interface 500F may include an “Add to new sheet” action element. The action element may allow a user 153 to persist the visualization object within the analytics application. The system 150 may receive, based on the insight object, a request to persist the visualization object. For example, the system 150 may receive the request in response to user selection of the action element. The system 150 may persist the visualization object to a sheet within the analytics application in response to receiving the request.

Referring to FIG. 5G, an analytics interface 500G illustrates an example of the user interface 200 of FIG. 2. The analytics interface 500G may present a comparison visualization within a main analytics application canvas, where the visualization is generated by the system 150 through the query-to-insight pipeline 400. The analytics interface 500G includes a natural language query input 502 to allow users 153 to enter queries for additional analyses, similar to the natural language query 162 and the natural language query 402. The analytics interface 500G further includes an insight summary 504 displayed below a visualization in the right panel. The insight summary 504 may state comparison values, similar to the refined narrative response 420 generated through the processing described with reference to the sequence diagram 300.

The system 150 may cause, based on an insight object and a selection state, a user interface to present the insight object while maintaining the selection state. For example, the analytics interface 500G may display a visualization while preserving a region selection. The selection state may be maintained by the associative engine 170 such that the visualization reflects the filtered data corresponding to the user's prior selections. The system 150 may cause, based on a request, an analytics application to store a visualization object in a report object. For example, the analytics interface 500G may include an “Add to new sheet” action element. A user 153 may select the action element to persist the visualization within the analytics application. The system 150 may store the visualization object such that the visualization becomes part of a sheet and/or the report object within the analytics application.

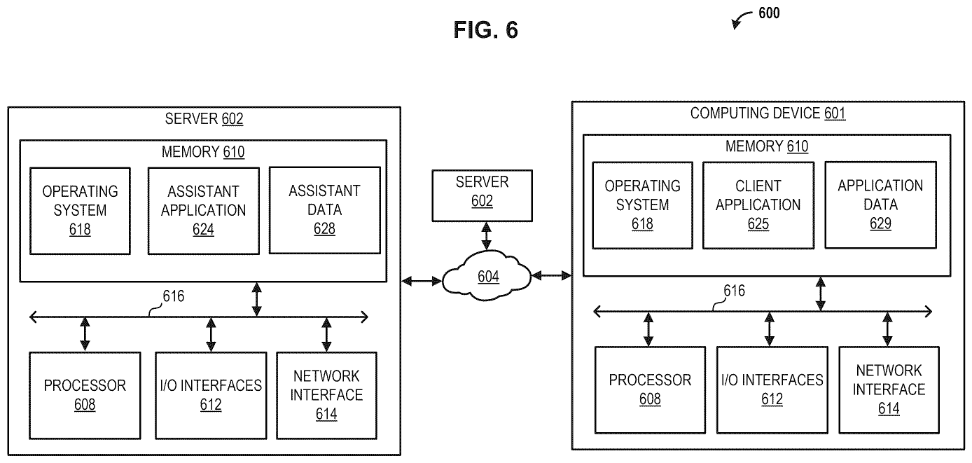

The present methods and systems may be computer-implemented. FIG. 6 shows a block diagram depicting a system/environment 600 comprising non-limiting examples of a computing device 601 and a server 602 connected through a network 604. Either of the computing device 601 or the server 602 may be a computing device, such as any of the devices of the system 100 shown in FIG. 1. In an aspect, some or all steps of any described method may be performed on a computing device as described herein. The computing device 601 may comprise one or multiple computers configured to store application data 629, and/or the like. The server 602 may comprise one or multiple computers configured to store assistant data 628. Multiple servers 602 may communicate with the computing device 601 via the through the network 604.

The computing device 601 and the server 602 may be a digital computer that, in terms of hardware architecture, generally includes a processor 608, system memory 610, input/output (I/O) interfaces 612, and network interfaces 614. These components (608, 610, 612, and 614) are communicatively coupled via a local interface 616. The local interface 616 may be, for example, but not limited to, one or more buses or other wired or wireless connections, as is known in the art. The local interface 616 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 608 may be a hardware device for executing software, particularly that stored in system memory 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the processor 608 may execute software stored within the system memory 610, to communicate data to and from the system memory 610, and to generally control operations of the computing device 601 and the server 602 pursuant to the software.

The I/O interfaces 612 may be used to receive user input from, and/or for providing system output to, one or more devices or components. User input may be provided via, for example, a keyboard and/or a mouse. System output may be provided via a display device and a printer (not shown). I/O interfaces 612 may include, for example, a serial port, a parallel port, a Small Computer System Interface (SCSI), an infrared (IR) interface, a radio frequency (RF) interface, and/or a universal serial bus (USB) interface.

The network interface 614 may be used to transmit and receive from the computing device 601 and/or the server 602 on the network 604. The network interface 614 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The system memory 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 610 may incorporate electronic, magnetic, optical, and/or other types of storage media. Note that the system memory 610 may have a distributed architecture, where various components are situated remote from one another, but may be accessed by the processor 608.

The software in system memory 610 may include one or more software programs, each of which comprises an ordered listing of executable instructions for implementing logical functions. In the example of FIG. 6, the software in the system memory 610 of the computing device 601 may comprise the application data 629, the client application 625, and a suitable operating system (O/S) 618. In the example of FIG. 6, the software in the system memory 610 of the server 602 may comprise the assistant data 629, the assistant application 624, and a suitable operating system (O/S) 618. The operating system 618 essentially controls the execution of other computer programs and provides scheduling, input-output control, file and data management, memory management, and communication control and related services.

For purposes of illustration, application programs and other executable program components such as the operating system 618 are shown herein as discrete blocks, although it is recognized that such programs and components may reside at various times in different storage components of the computing device 601 and/or the server 602. An implementation of the system/environment 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

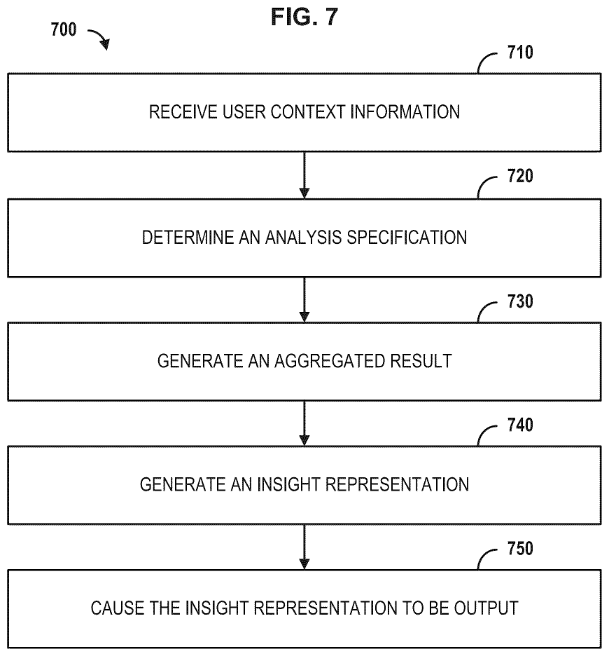

Referring to FIG. 7, a method 700 for generating insights from source data based on user context is illustrated. The method 700 may be performed by a computing device, such as the client device 102 or the computing device 601 (shown in FIG. 6), a server such as the server 602 (FIG. 6), or a combination thereof. The method 700 may be implemented using components of the system 100 and the system 150. The method 700 may enable proactive generation of insights without requiring explicit user queries, such as the natural language query 162.

The method 700 begins with step 710. At step 710, user context information may be received. The user context information may identify a user role associated with a user session. For example, the user context information may indicate that a user, such as one of the users 153, is a member of an executive team, a sales manager, a regional director, or another organizational role. The user context information may be derived from access control data, authentication credentials, or user profile information stored within the analytics platform. The user context information may correspond to the context 166 gathered by the associative engine 170, which may include data hypercubes, selection states, data model schemas, and query history. The user context information may also include historical interaction patterns, previous queries, and data access permissions associated with the user.

At step 720, an analysis specification may be determined. The analysis specification may define a data analysis not explicitly requested by the user. The analysis specification may be determined based on the user role identified in the user context information. For example, the system 150 may determine that users with similar roles generally perform similar data analyses. The analysis specification may identify an analysis type, dimensions, measures, filters, and aggregation functions to be applied to source data retrieved from the data stores 106, 108, 110. The analysis specification may correspond to a predefined analysis type from a catalog of analysis types, similar to the intent classification 410 that categorizes the analytical purpose of queries. The predefined analysis type may include period-over-period change analysis, trend detection, anomaly detection, contribution analysis, ranking shift analysis, or variance to target analysis, as indicated by, for example, the analysis type indicator 230B. Other analysis types are possible as well. The method 700 may support two workflow paths for determining the analysis specification. For example, in a first workflow path for generic applications, the analytics application may lack pre-existing context, and the user may create context within a trigger definition to define the analysis specification. The trigger definition may specify conditions under which insight generation should occur, such as threshold crossings, anomaly detection, or external events. The user may define the trigger expression by specifying the relevant measures, dimensions, and threshold conditions within the trigger definition. In a second workflow path for curated applications, the analytics application may include a semantic layer comprising master items and sheets. For example, in the second workflow path, the system 150 may automatically suggest the analysis specification based on the semantic layer. For example, the system 150 (e.g., via the LLM(s) 160) may identify master items defining reusable dimensions and measures, and may identify sheets containing visualization layouts, and may use these semantic layer elements to recommend the analysis specification without requiring the user to build trigger expressions from scratch.

The method 700 continues to step 730. At step 730, an aggregated result may be generated. The aggregated result may be generated by executing the data analysis on source data retrieved from the plurality of data stores 106, 108, 110 via the network 104. The aggregated result may be generated via the associative engine 170/the associative engine 102B of the client device 102. The associative engine 170 may execute a hypercube definition corresponding to the analysis specification, as described with reference to step 306 of the sequence diagram 300. The hypercube definition may specify dimensions, measures, and aggregation functions, similar to the dimensions indicator 230D and the measures indicator 230E. The associative engine 170 may return an n-dimensional aggregated dataset comprising computed values, dimensional breakdowns, and filter context, as described with reference to step 308. The system may persist hypercube definitions, selection states, and app version identifiers to support reproducibility of insights. The persisted information may enable the system to trace an insight to the app state from which the insight was generated.

At step 740, an insight representation (e.g., an insight card, as described herein) may be generated. The insight representation may be generated based on the aggregated result. The insight representation may comprise a narrative text and a visualization object. The narrative text may describe the aggregated result, similar to the insights found 220 comprising the first insight 220A, second insight 220B, and third insight 220C. The visualization object may comprise a chart definition, a rendered chart image, or both, similar to the chart 202 generated based on the visualization recommendations 412.

The narrative text may be generated based on a narrative template. The narrative template may comprise parameterized statements corresponding to the analysis type, similar to the template narrative statements 414. The parameterized statements may be populated with values computed from the aggregated result, producing the template-based narrative output 416. The narrative text generated from the narrative template may be referred to as template-based narrative text.

A refined narrative text may be generated based on the narrative text and a large language model, such as the large language model 160 or the primary LLM 160A. The large language model may rewrite or refine the template-based narrative text to improve clarity, correctness, tone, and readability, as described with reference to step 320 of the sequence diagram 300 and the LLM request prompts 418. The refined narrative text may replace the narrative text in the insight representation, producing the refined narrative response 420. When model processing occurs in external services, the system may minimize sensitive exposure by sending only aggregated values and metadata, redacting identifiers, and performing local inference for sensitive tenants. Other privacy-preserving techniques are possible as well.

The method 700 may further comprise determining, based on access control data, that the user associated with the user session is authorized to receive the insight representation. The access control data may specify role-based permissions, field-level access restrictions, and row-level security constraints, as described with reference to the analytics dashboard interface 500D where access control information may operate at multiple layers including app-level access, field-level access, and row-level access. The system may enforce access control at multiple layers before delivering the insight representation. Personalization may be constrained by governance and fairness considerations to respect role boundaries and avoid exposing insights outside a user's permitted scope.

At step 750, the insight representation may be caused to be output. The insight representation may be output within a feed interface. For example, the insight representation may be output within the insight feed interface 500B, the analytics interface 500C, or the analytics dashboard interface 500D. The insight feed interface 500B may present the insight representation as a card-like object. The card-like object may include the narrative text, the visualization object, and action elements. The action elements may enable a user to explore underlying data, add a visualization to a sheet as shown in the insight interface 500F and the analytics interface 500G, or share the insight with other users. The insight representation corresponds to the answer 168 generated by the assistant application 158 and delivered to the users 153 via the client device 102.

The system may learn from user interaction with insights through feedback signals. The feedback signals may include explicit ratings, dismissals, shares, saves, drill-down actions, time spent viewing an insight, etc. The method 700 may further comprise causing, based on feedback received from a client device such as the client device 102, the feed interface to reprioritize subsequent insight representations. The feedback may tune scoring, ranking, and selection of analysis types for future insight generation, as described with reference to the candidate insight scoring performed by the system 150 before delivery to the insight feed interface 500B. The system may track which dimensions and measures users frequently explore and which analysis types users find useful. Other feedback mechanisms are possible as well.

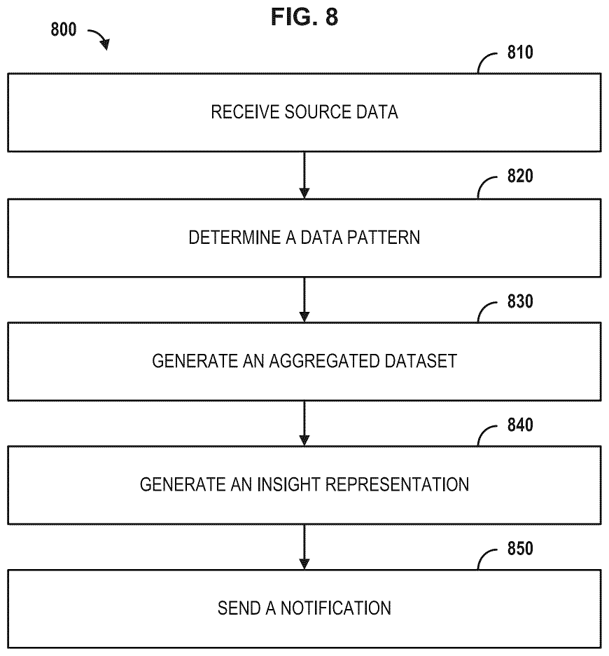

Referring to FIG. 8, a method 800 for generating insights from source data based on a data reload event is illustrated. The method 800 may be performed by a computing device, such as the client device 102 or the computing device 601, in communication with an associative engine, such as the associative engine 170, and one or more machine learning models, such as the large language model 160, the primary LLM 160A, and the secondary LLM 160B. The method 800 may be implemented using components of the system 100 and the system 150. Proactive insight generation may be invoked at data reload, on a schedule, or in response to detected changes in the source data retrieved from the plurality of data stores 106, 108, 110 via the network 104.

The method 800 begins with step 810 of receiving source data. The source data may be received based on a data reload event for an analytics application. The source data may comprise current data and historical data, similar to the data 152 that is processed through the data conversion process 154. The current data may represent data loaded during the data reload event. The historical data may represent data from previous reload cycles or time periods. The source data may be retrieved from one or more data stores, such as the first data store 106, the second data store 108, and the third data store 110, connected via the network 104. The source data may be stored in the vector database 156 as embeddings created during the create embeddings step 154C.

With continued reference to FIG. 8, the method 800 proceeds to step 820 of determining a data pattern. The data pattern may be determined based on the source data and the historical data. The data pattern may indicate a deviation from an expected metric value. Pattern detection may be performed by, as an example, the machine learning module 102A using statistical and machine learning techniques. For example, pattern detection may use moving averages to identify trends in the source data. Pattern detection may use standard deviation thresholds to identify outliers. Pattern detection may use time-series decomposition to separate seasonal components from underlying trends. Pattern detection may use clustering techniques to group similar data points and identify anomalies. Pattern detection may use learned anomaly scores generated by machine learning models, such as the large language model 160, trained on historical data patterns. The pattern detection corresponds to the intent classification 410 that categorizes the analytical purpose of queries, where analysis types may include trend detection, anomaly detection, and period-over-period change analysis as indicated by the analysis type indicator 230B. Other pattern detection techniques are possible as well. The system 150 may employ machine learning libraries for pattern detection calculations. For example, the machine learning module 102A may execute pattern detection using peak-finding algorithms to identify significant spikes based on dynamic thresholds for prominence and height. Pattern detection may include baseline shift analysis using statistical measures such as mean, median, and z-scores to detect changes in baseline values. Pattern detection may include model deviation analysis using time-series forecasting models to compare actual data against model predictions and identify deviations. Pattern detection may include record detection to identify record high or low values and compare them to historical records. Pattern detection may further include trend change analysis using regression techniques to detect changes in trends by comparing slopes of historical and current segments.

The method 800 may further comprise determining, based on a predefined threshold, that the deviation satisfies an alert condition. The predefined threshold may be configured by a user, such as one of the users 153, or an administrator. The predefined threshold may specify a magnitude of change, a z-score value, or a percentage deviation from the expected metric value. The threshold determination corresponds to the candidate insight scoring performed by the system 150 before delivery to the insight feed interface 500B, where scoring may consider magnitude including absolute change, relative change, z-score, or anomaly score. When the deviation satisfies the alert condition, the method 800 may proceed to generate an insight representation. After pattern detection calculations are completed, the system 150 may apply a sensitivity algorithm to determine whether a detected pattern is significant enough to present. The sensitivity algorithm may account for chronological order, such as the newness of the insights, and weight, such as the impact of the insights on the source data. In some embodiments, the system 150 may generate a forecast based on data provided up to a current time period. From this forecast, a range may be established for expected data point values. The sensitivity level may be set based on how many data points reside within the forecast range, so as not to overwhelm the user with excessive alerts. The forecast may be based on linear regression or other forecasting techniques. The sensitivity may not be static but may adjust algorithmically to ensure quality insights are generated. The algorithm may be calibrated based on historical data points residing within the forecast. The number of standard deviations may be used for defining anomalies, and sensitivity may be based on that number.

As further shown in FIG. 8, the method 800 continues to step 830 of generating an aggregated dataset. The aggregated dataset may be generated based on the data pattern. The aggregated dataset may be associated with the deviation from the expected metric value. The method 800 may further comprise generating, via an associative engine, the aggregated dataset. For example, the associative engine 170/102B may generate the aggregated dataset by computing measures across dimensions and filters, as described with reference to step 306 and step 308 of the sequence diagram 300. The associative engine may generate a hypercube definition specifying dimensions, measures, and aggregation functions, similar to the dimensions indicator 230D and the measures indicator 230E. The aggregated dataset may include computed values supporting the identified data pattern, corresponding to the context 166 gathered by the associative engine.

The method 800 proceeds to step 840 of generating an insight representation. The insight representation may be generated based on the aggregated dataset. The insight representation may comprise a visualization and a narrative summary describing the deviation, similar to the chart 202 and the insights found 220 comprising the first insight 220A, second insight 220B, and third insight 220C. The method 800 may further comprise generating, based on a trend analysis type, the visualization. The trend analysis type may specify a line chart, a bar chart, or another visualization type suitable for displaying temporal patterns, as determined by the visualization recommendations 412 and indicated by the chart type indicator 230A. The visualization may display the deviation from the expected metric value over time, similar to the visualizations presented in the insight feed interface 500B and the analytics interface 500C.

The method 800 may further comprise generating, based on a narrative template, the narrative summary. The narrative template may include parameterized statements populated with values computed from the aggregated dataset, similar to the template narrative statements 414 that produce the template-based narrative output 416. The narrative summary may describe the magnitude of the deviation, the time period of the deviation, and contributing factors identified through the pattern detection. A large language model, such as the primary LLM 160A, may refine the narrative summary to improve clarity and readability, as described with reference to step 320 of the sequence diagram 300 and the LLM request prompts 418, producing the refined narrative response 420.

The method 800 concludes with step 850 of sending a notification. The notification may be sent to a client device. For example, the notification may be sent to the client device 102 or the computing device 601. The notification corresponds to the answer 168 generated by the assistant application 158 and delivered to the users 153. The method 800 may further comprise sending, based on user profile data, the notification via a preferred communication channel. The preferred communication channel may be an in-app notification, an email notification as shown in the insight notification interface 500A, or a push notification. The user profile data may specify the preferred communication channel for each user 153. The notification may include the insight representation or a summary of the insight representation with a link to view additional details, enabling the user to access the insight through the insight feed interface 500B, the analytics interface 500C, or the analytics dashboard interface 500D.

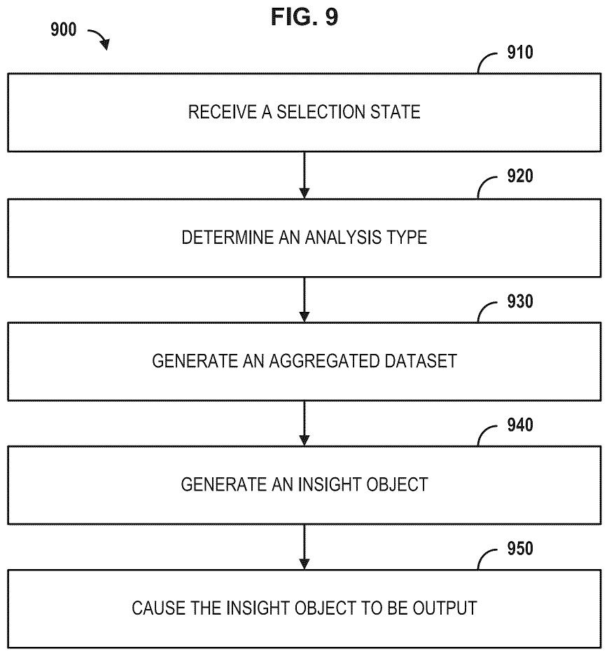

Referring to FIG. 9, a method 900 for generating insights based on a selection state applied to source data is illustrated. The method 900 may be performed by a computing device, such as the client device 102 or the computing device 601, a server such as the server 602, or a combination thereof. The method 900 may be implemented using components of the system 100 and the system 150. The method 900 may enable generation of insights responsive to user interactions with an analytics interface, such as the user interface 200, the analytics interface 500C, or the analytics dashboard interface 500D.

At step 910, a selection state may be received. The selection state may be based on interaction with a user interface. For example, the selection state may be based on interaction with the user interface 200, the analytics interface 500E, or the analytics interface 500G. The selection state may represent one or more filter conditions, dimension selections, or data element selections applied by a user 153. The selection state may define a subset of source data to be analyzed, where the source data may be retrieved from the plurality of data stores 106, 108, 110 via the network 104. The selection state may be received from a client device such as the client device 102 or from the associative engine 170 maintaining current user context. The selection state corresponds to the context 166 gathered by the associative engine 170, which may include data hypercubes, current selection states, data model schemas, and query history as described with reference to step 306 of the sequence diagram 300.

At step 920, an analysis type may be determined. The analysis type may be determined from a predefined set of analysis types. For example, the analysis type may correspond to the intent classification 410 performed by the query-to-insight pipeline 400. The analysis type may also correspond to the analysis type indicator 230B, which indicates the analysis type such as “Ranking” or “Comparison.” The predefined set of analysis types may include comparison, ranking, trend detection, anomaly detection, contribution analysis, period-over-period change, variance to target, or other analysis patterns. The analysis type may be determined based on the selection state, based on characteristics of selected data elements, or based on user context information. The analysis type determination may be performed by, as an example, the secondary LLM 160B as described with reference to step 314 of the sequence diagram 300. The analysis type may constrain the form of analysis to be performed and may reduce noise in generated insights.

At step 930, an aggregated dataset may be generated. The aggregated dataset may represent a comparison. For example, the aggregated dataset may represent a comparison between two or more data segments, between two or more time periods, or between two or more dimensional values, similar to the comparison presented in the insight interface 500F and the analytics interface 500G. The aggregated dataset may be generated by executing a hypercube definition against source data filtered according to the selection state, where the hypercube execution is performed by, as an example, the associative engine 170 as described with reference to step 306 and step 308 of the sequence diagram 300. The associative engine 170 may store data models in-memory and manage associations between data elements, providing near-instantaneous calculation of aggregates, selections, and filters. Structured data within the aggregated dataset may be represented through feature vectors. The feature vectors may be reduced in dimensionality using techniques such as principal component analysis or autoencoders, as described with reference to the data conversion process 154. Other dimensionality reduction techniques are possible as well.

Based on the aggregated dataset, an outlier associated with the comparison may be determined. The outlier may represent a data point, a dimensional value, or a segment that deviates from expected patterns within the comparison. The outlier may be identified using statistical techniques, machine learning models provided by the machine learning module 102A, or threshold-based detection. The outlier detection may be performed as part of the pattern detection described with reference to the method 800, where the system determines data patterns indicating deviations from expected metric values. Determining the outlier may enable the method 900 to highlight data elements warranting user attention, similar to the insights found 220 comprising the first insight 220A, second insight 220B, and third insight 220C.

At step 940, an insight object may be generated. The insight object may be generated based on the aggregated dataset. The insight object may comprise a visualization object and a narrative description, similar to the chart 202 and the answer 168 generated by the assistant application 158. The visualization object may present the comparison in graphical form. For example, the visualization object may comprise a scatter plot as shown in the insight interface 500F and the analytics interface 500G, a bar chart as shown in the chart 202, or another chart type appropriate for the comparison based on the visualization recommendations 412. The narrative description may describe findings from the aggregated dataset in natural language, similar to the refined narrative response 420 generated by the query-to-insight pipeline 400 and the insight summary 504.

Based on the outlier, a visual emphasis may be generated within the visualization object. The visual emphasis may highlight the outlier within the visualization object. For example, the visual emphasis may comprise a distinct color, a marker, an annotation, or another graphical indicator applied to the outlier, similar to the visual representations shown in the chart 202 and the scatter plot visualizations in the insight interface 500F and the analytics interface 500G (FIG. 5G). The visual emphasis may direct user attention to the outlier within the visualization object.

At part of step 940, the system 150 may validate outputs for security and governance before generating the insight object, as described with reference to step 322 of the sequence diagram 300. The system 150 may check for ungrounded statements within the narrative description. The system 150 may format the response before returning a final answer. Grounding may be achieved by restricting model inputs to aggregated results and authorized metadata retrieved from the vector database 156. Grounding may also be achieved by validating model outputs against computed values generated by the associative engine 170. The system 150 may encrypt prompts in transit when communicating with the large language model 160, the primary LLM 160A, or the secondary LLM 160B. The system 150 may store audit logs for compliance. Other examples are possible as well.

At step 950, the insight object may be caused to be output. The insight object may be output while maintaining the selection state. Maintaining the selection state may enable a user 153 to explore the insight object within the same analytical context, as demonstrated in the analytics interface 500G where the visualization is presented while preserving a region selection. The insight object may be output to a user interface such as the user interface 200, to a feed such as the insight feed interface 500B, or to a notification channel such as the insight notification interface 500A. The insight object corresponds to the answer 168 generated by the assistant application 158 and delivered to the users 153 via the client device 102, as described with reference to step 324 of the sequence diagram 300. The system 150 may store snapshots to reproduce evidence supporting the insight object. The system 150 may track version identifiers for app artifacts associated with the insight object. Storing snapshots and tracking version identifiers may enable reproducibility of the insight object. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, based on a user session associated with an analytics application, user context information;
determining, based on the user context information, an analysis specification defining a data analysis not explicitly requested via the user session;
generating, via an associative engine and based on the analysis specification, an aggregated result, wherein the associative engine executes the data analysis on source data accessible to the analytics application; and
generating, based on the aggregated result, an insight representation, wherein the insight representation is based on the source data.

2. The method of claim 1, wherein the insight representation comprises a narrative text, and wherein the narrative text describes the aggregated result.

3. The method of claim 2, further comprising generating, based on a narrative template, the narrative text, wherein the narrative template is selected based on the user context information.

4. The method of claim 1, wherein determining the analysis specification comprises:
for a generic application lacking a semantic layer, receiving a user-defined trigger expression; and
for a curated application comprising the semantic layer, automatically suggesting the analysis specification based on the master items and sheets.

5. The method of claim 4, further comprising generating, via a large language model, a refined narrative text, the refined narrative text replacing the narrative text.

6. The method of claim 1, further comprising determining, based on access control data, that the user associated with the user session is authorized to receive the insight representation.

7. The method of claim 1, further comprising causing, based on feedback received from the client device, the feed interface to reprioritize subsequent insight representations.

8. A method comprising:
receiving, via an analytics application, source data comprising current data and historical data;
determining, based on the source data and the historical data, a data pattern indicating a deviation from an expected metric value;
generating, based on the data pattern, an aggregated dataset associated with the deviation from the expected metric value;
generating, based on the aggregated dataset, an insight representation indicative of the deviation; and
sending, to a client device, a notification comprising the insight representation, wherein the client device is caused to output the insight representation.

9. The method of claim 8, wherein receiving the source data comprises receiving, based on a data reload event, the source data, wherein the current data represents data loaded during the data reload event.

10. The method of claim 8, further comprising generating, via an associative engine, the aggregated dataset, wherein the associative engine is associated with the analytics application.

11. The method of claim 8, further comprising generating, based on a trend analysis type, the visualization, wherein the trend analysis type specifies a line chart or a bar chart for the visualization.

12. The method of claim 8, further wherein generating the insight representation comprises generating, based on a narrative template, a narrative summary, wherein the narrative summary comprises values computed from the aggregated dataset and associated with the deviation.

13. The method of claim 8, further comprising sending, based on user profile data, the notification via a preferred communication channel, wherein the user profile data specifies the preferred communication channel.

14. A method comprising:
receiving, based on an analytics application, a selection state applied to source data, wherein the analytics application is associated with the source data;
determining, based on the selection state, an analysis type;
generating, based on the analysis type and the selection state, an aggregated dataset representing a comparison between multiple measures; and
generating, based on the aggregated dataset, an insight object, wherein the insight object is indicative of the comparison between the multiple measures.

15. The method of claim 14, further comprising determining, based on the aggregated dataset, an outlier associated with the comparison.

16. The method of claim 15, further comprising generating, based on the outlier, a visual emphasis within the insight object.

17. The method of claim 14, further comprising generating, based on a narrative template, a narrative description, wherein the narrative template is associated with the comparison.

18. The method of claim 14, further comprising receiving, based on the insight object, a request to persist the visualization object.

19. The method of claim 18, further comprising causing, based on the request, the analytics application to store the visualization object in a report object.

20. The method of claim 14, further comprising receiving, based on the insight object, a follow-up natural language request and determining, based on the follow-up natural language request, an additional analysis type.
